(19) United States
(12) Patent Application Publication
(10) Pub. No.: US 2010/0042702 A1
(43) Pub. Date: Feb. 18, 2010

(54) Bookmarks for Flexible Integrated Access to Published Material

(76) Inventor: Philip C. Hanses, East Lansing, MI (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/190,933

(22) Filed: Aug. 13, 2008

(51) Int. Cl. G06F 15/16; H04L 9/32; G10L 11/00; G10L 15/00

(52) U.S. Cl. 709/219; 726/3; 704/275; 704/E15.001

(57) ABSTRACT

Methods, systems, and apparatus, including medium-encoded computer program products, can provide bookmarks for flexible integrated access to media content. A method includes providing a user with access to media content via a first delivery mechanism of multiple delivery mechanisms. Delivery mechanisms include one or more delivery mechanisms that deliver an audio rendering of the media content and one or more that deliver a visual rendering. A request to bookmark a stopping point in the media content is received. A relative position in the media content based on the stopping point is determined and stored. A request for access to the media content via a second delivery mechanism is received. The relative position is received and used to determine a starting point for playback of the media content via the second delivery mechanism. Access to the media content is provided via the second delivery mechanism at the starting point.

### TECHNICAL FIELD

This description relates to delivery of media, and more particularly to bookmarks for flexible integrated access to published material.

### BACKGROUND

Books, magazines, and other published material are typically made available in printed or printable formats. Recordings of read books became in vogue during the 1980s and such audio versions of the books have been made available on compact discs, cassette tapes, and, more recently, personal computers using downloadable digital formats, such as Moving Picture Experts Group-3 (MPEG-3) and Windows Media Audio (WMA). With the advent of the Internet, audio versions of books can be downloaded online to virtually any computer or device connected to the Internet, including smart phones and personal listening devices.

### SUMMARY

This specification describes technologies relating to bookmarks for flexible integrated access to published material.

In one general aspect, a method includes providing a user with access to media content via a first delivery mechanism of multiple delivery mechanisms. The delivery mechanisms include at one or more delivery mechanisms operable to deliver an audio rendering of the media content and one or more delivery mechanisms operable to deliver a visual rendering of the media content. A request from the user to bookmark a stopping point in the media content is received. A relative position in the media content based on the stopping point is determined and stored. A request from the user for access to the media content via a second delivery mechanism is received. The relative position is received and used to determine a starting point for playback of the media content via the second delivery mechanism. The user is provided access to the media content via the second delivery mechanism beginning at the starting point. Other embodiments of this aspect include corresponding systems, apparatus, and computer program products.

These and other embodiments can optionally include one or more of the following features. The request from the user to bookmark can be initiated by the user issuing a voice command; and the embodiments can also include automatically determining the relative position and storing the relative position in response to the voice command. The embodiments can further include receiving a request for access by the user to the media content via the first delivery, verifying that the user has permission to access the media content, and determining whether a relative position in the media content has been previously stored. If a relative position has been previously stored, the embodiments can also include retrieving the relative position, determining a particular starting point for playback of the media content via the first delivery mechanism based on the relative position, and providing the user with access to the media content via the first delivery mechanism. The access via the first delivery mechanism can begin at the particular starting point. If a relative position has not been previously stored, the embodiments can further include providing the user with access to the media content via the first delivery mechanism. The access via the first delivery mechanism can begin at a default starting point of the media content.

The one or more delivery mechanisms can be operable to deliver the audio rendering comprises at least one of: an internet connection, a mobile phone network, and a vehicle-enabled access network. Providing the user with access to the media content via the first delivery mechanism can be operable to deliver a visual rendering of the media content, and the second delivery mechanism can be operable to deliver an audio rendering of the media content. The request from the user to bookmark a stopping point can be submitted manually by the user and can identify a location in a hard copy of the media content. The particular point can include a page and paragraph number in the media content. The stopping point can be in the middle of a particular paragraph and the starting point can be at the beginning of the particular paragraph.

The details of one or more embodiments of the invention are set forth in the accompanying drawings and the description below. Some advantages include increased consumer satisfaction due to the ability to access to the published material in a variety of settings. Not having to purchase multiple copies of the same book in different formats can potentially save consumers time and money. Being able to electronically bookmark a published material can also provide convenience for a consumer by seamlessly allowing a user to switch between various delivery methods. The increase in convenience can also lead to an increase in consumption by the consumer and thus increased profits for content providers, who may benefit from having an increased customer base at a small incremental cost. Other features, objects, and advantages of the invention will be apparent from the description and drawings, and from the claims.

### DESCRIPTION OF DRAWINGS

FIG. 1 is an overview of a system for flexible delivery of published material.

FIG. 2 is a block diagram of a content service provider for flexible delivery of published material using electronic bookmarking.

FIG. 3A is a flowchart of a process for flexible integrated delivery of published material.

FIG. 3B is a flowchart of a process for subscribing to a flexible integrated delivery of published material.

FIG. 3C is a flowchart of a process for electronic bookmarking.

FIG. 4 is a flow diagram of a process for flexible integrated delivery of published material.

Like reference symbols in the various drawings indicate like elements.

### DETAILED DESCRIPTION

Published material can be made available via a variety of delivery mechanisms or channels. For example, one can simply purchase a book at a local bookstore and begin reading it. The same book content may be available in electronic form and can, for example, be purchased over the Internet for delivery to a local computer. The same book content may also be made available as an audio book (e.g., as a voice recording of the content) allowing a user to listen to it in the car or on a personal digital listening device such as an MP3 player. Systems, methods, and computer program products can be realized to provide flexible integrated access to published material.

A content server can store media content in a variety of formats. A user can subscribe to receive the content of one or more publications from the content server. The user can have the media content delivered to any of a number of end user devices, such as, for example, a mobile telephone, a computer, or integrated vehicle communications system (e.g., OnStar by General Motors). The content provider can process a request for media content from a user, verify that user has permission to access the media content, and deliver the media content to the user's device via one of a variety of formats and delivery channels. For example, the content can be delivered to a user's mobile smartphone in an audio file (e.g., a WAV, a MP3, or other format) using a wireless network. As another example, the content can be delivered to a user's desktop computer in an electronic document file (e.g., an HTML, a PDF, or other format) using the Internet. The content server can also store electronic bookmarks for the user, which can be used to by the content server to determine where to begin future playback of the media content. During playback on a user's device, the user can set an electronic bookmark at a particular point in the media content and later access the media content on a different device starting at that particular point.

Consumers can benefit by conveniently listening to a book or magazine via an in-vehicle communications system. Not having to purchase multiple copies of the same book in different formats can potentially save consumers time and money. Being able to electronically bookmark a published material can also provide convenience for a consumer by seamlessly allowing a user to switch between various delivery methods. The increase in convenience can also lead to an increase in consumption by the consumer and thus increased profits for content providers, who may benefit from having an increased customer base at a small incremental cost. These and other advantages may not apply to all embodiments.

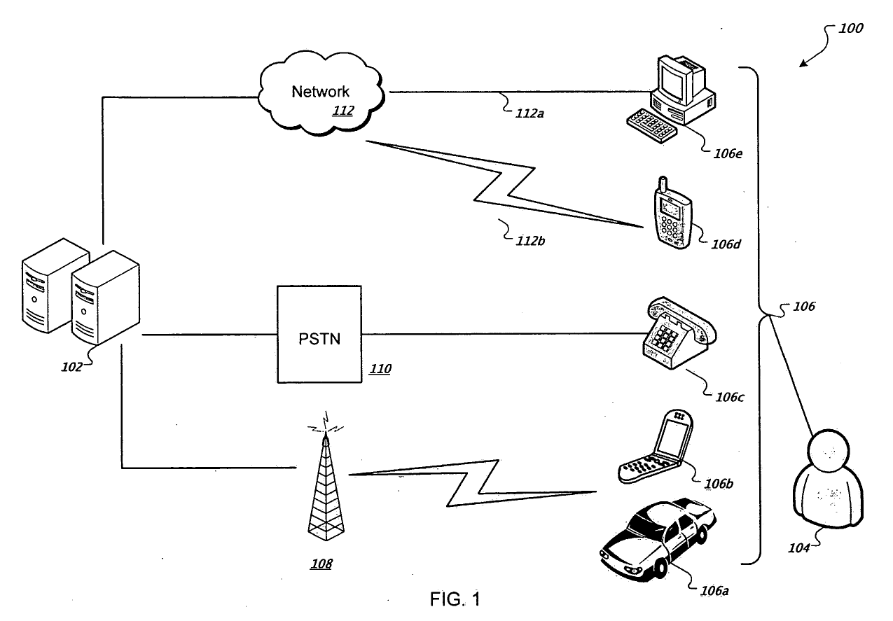

FIG. 1 is an overview of a system 100 for flexible delivery of published material. In general, a content server 102 can receive a request from a registered user 104 to access published material on a communications device 106. The user 104 can later request access to the published material on another communication device 106. The content server 102 can communicate with the communications devices 106 using any number of delivery mechanisms or communication channels. For example, content server 102 can deliver media content over a mobile network 108 by establishing a connection with a vehicle communications system 106a or a cellular telephone 106b, and playing an audio rendering of the media content over the connection. As another example, the content server 102 can deliver media content over an ordinary telephone line (at 110) by connecting to a telephone 106c and playing an audio rendering of the media content over the connection. Another example involves the content server 102 delivering media content to a smartphone 106d or computer 106e using the network 112 by transmitting an electronic file, such as an audio file, a text document, and/or a graphics file. The files can be delivered in a variety of formats that include, by way of example, WAV, AAC, MP3, and WMA for audio, HTML, PDF, and RTF for text documents, and JPEG, TIFF, and BMP for image files. Audio delivered to the user can include a recording of a human reading the media content and speech generated by a computer from the text of the media content. The computer-generated audio can be created and stored prior to a request for the media content. The computer-generated audio can also be created at the time of delivery of the media content.

A content server 102 provides published material to a user 104 via a particular one of the multiple delivery mechanisms that is convenient for the user 104 at a given time. The content server 102 can track multiple users or subscribers, their respective permissions to access published material, and their respective electronic bookmarks. The content server 102 can use one or more storage devices to store data related to subscribers and to store electronic content corresponding to published materials. To deliver content, the content server 102 can utilize a content distribution network (CDN), which is a system of computers networked together across the Internet that cooperate transparently to deliver content to end users. CDN nodes are deployed in multiple locations, often over multiple backbones. These nodes cooperate with each other to satisfy requests for content by end users, potentially reducing bandwidth costs and/or improving end-user performance.

The content server 102 can also communicate via a variety of delivery mechanisms. A delivery mechanism can include one or more of, or a combination of, a transmission medium, a transmission format, and a presentation to a user. For example, one delivery mechanism can be audio delivery of published material over a public switched telephone network (PSTN) 110 for playback on a telephone 106c. Another delivery mechanism can be, for example, visual text delivery of published material over a packet switched network 112 and/or wireless packet switched network 112b for display on a smartphone 106d. The same transmission medium and end communication device 106 can be used to realize multiple delivery mechanisms. For example, visual text delivery of published text to a smartphone 106d and audio delivery of published material to the same smartphone 106d may be provided according to the preference of the user, and both forms of media content may be transmitted over the network 112 and wireless network 112b. As another example, computer generated audio and human read audio can be associated with different delivery mechanisms even if they are delivered over the same transmission medium and using the same end communication device 106.

Four example transmission media are shown in FIG. 1, mobile network 108, PSTN 110, and packet-switched, Internet-connected wired network 112a and wireless network 112b. These illustrated transmission media are merely examples, and transmission media that are combinations of these four example media as well as other transmission media can be used with system 100.

Mobile network 108 can communicate with or include a wide area cellular telephone network. Mobile network 108 can communicate using a variety of standards and/or protocols, including, for example, Wideband Code Division Multiple Access (W-CDMA), High-Speed Downlink Packet Access (HSDPA), Enhanced Data Rates for GSM Evolution (EDGE), General Packet Radio Services (GPRS) and Global System for Mobile Communication (GSM). Portions of mobile network 108 may be administered by a wireless service provider, such as T-Mobile®, Verizon Wireless®, or Sprint Nextel®, for example. Subscribers or users 104 of the wireless service may receive published material through a vehicle communications system 106a, mobile telephone 106b, or other mobile device capable of communicating with mobile network 108. Vehicle communications system 106a is a communication system typically integrated with an automobile's audio and communications system. Vehicle communications systems 106a can communicate over a mobile network 108 transmitting voice and/or data. Examples of vehicle communications systems 106a include OnStar® by General Motors, BMW Assist® by BMW, and TeleAid by Daimler AG (Mercedes-Benz). Mobile telephones 106b can include any cellular telephone, smartphone, Blackberry device, or Pocket PC that communicates over a mobile network 108. Some mobile devices 106b are capable of displaying text as well as communicating voice data. In addition to voice, some mobile devices 106b can also communicate data over the mobile network 108.

The PSTN 110 is a network of public circuit-switched telephone networks. The PSTN 110 provides telecommunications access to millions of homes in the United States and throughout the world and allows individuals to communicate voice and data to one another. The telephone 106c can be used to communicate sounds over the PSTN 110.

Accordingly, the PSTN 110 can be used to communicate audio renderings of published material through the telephone 106c. The telephone 106c can also be a modem, which can receive and transmit data over the PSTN 110. Using a modem, the PSTN 110 can be used to deliver electronic visual renderings of published material.

Network 112 is a packet switched IP-based network primarily used to communicate data. The network 112 can be, include, or otherwise communicate with wireless 112b and/or wired 112a personal, local, metropolitan, regional and/or wide area networks, and/or the Internet. Examples of wireless networks 112b include networks conforming to Institute of Electrical and Electronics Engineers (IEEE) 802.11 related standards and/or IEEE 802.16 related standards (Wireless Metropolitan Area Networks). A variety of end user devices 106 can be connected to network 112 for use in delivering published material to a user 104. For example, a personal computer 106e or a portable device 106d can be connected to the network 112. A portable device 106d can be any network-enabled device that can send and receive information over a wireless network 112b. For example, many smartphones, which can also function as mobile telephones 106b, and personal listening devices, such as the iPod Touch® by Apple Computer of Cupertino, Calif., can connect to wireless networks 112b and ultimately to the Internet. These portable devices 106d can include screens for rendering visual data and speakers for rendering audio data. A computer 106e can be any general purpose or special purpose computing machine that can access a network 112, whether it be wired 112b or wireless 112a, to retrieve and render published material for user 104. Examples of computers 106e include, by way of example only, desktop and laptop computers, PocketPCs, Blackberry devices, and specialized portable reading devices that connect to a network 112. The network 112 can be used to deliver visual, audio, and virtually any type of data associated with rendering of published material, such as tactile data associated with Braille, which can be displayed using an appropriate output device.

In operation, a user 104 subscribes or registers with the content server 102 to have access to published material via a variety of delivery mechanisms. The potential levels of subscriptions are diverse. Subscriptions can be based on a per access, a per published material, a per time period, or any other basis that the market can support. The control of whether to fulfill a request by a user 104 for certain published material can be handled using permissions associated with each user 104 or groups of users 104.

After subscribing to the service, a user 104 uses an end communications device 106, such as a computer 106e, to communicate to the content server 102 a request access to published material. The content server 102 can verify that the user 104 has permission to access the requested published material. If the user 104 has permission, the content server 102 can search for, detect, or otherwise be provided with the delivery mechanism for use in delivering the published material. The content server 102 can determine the appropriate and/or preferred delivery mechanism using preferences associated with a user 104, such as a preference for audio read with a human voice when available and/or a preference for delivery of a visual rendering when an end communications device 106 supports both visual and audio renderings. The content server 102 can determine the appropriate and/or preferred delivery mechanism using defaults associated with delivery of published material. For example, delivery to a vehicle communications system 106a may be computer-generated audio by default.

If the request by the user 104 is the first request for the particular published material, the content server 102 can deliver the published material beginning at a default point, which can be the published material's first sentence. If the delivery is via an audio mechanism, the audio can begin reading from the default point in the published material. If the delivery is via a visual mechanism, the screen can display the default point, which may be the first page or first sentence of the published material.

At any point while listening to and/or reading the published material, the user 104 can stop and bookmark the stopping point. For example, a user 104 who is listening to the published material using a vehicle communications system 106a can issue a voice command to stop and bookmark the stopping point. As another example, a user 104 who is reading the published material via a computer 106e can issue an online request or command to bookmark a current location. Upon receiving a command or request to bookmark a point in the published material for the user 104, the content server 102 can create an electronic bookmark that can be used to determine the starting point the next time the user with accesses that particular published material, irrespective of the end communications device that is used in the subsequent access. For example, a user 104 who is listening to published material, such as a home electronics magazine, being read over the telephone 106c can request a bookmark at a particular point in the audio playback. If the same user 104 later accesses the home electronics magazine via a visual delivery mechanism using a computer 106e, the system can search for the last bookmark the user 104 associated with the home electronics magazine and begin playback from the last bookmarked point, even though the bookmark was created using a different delivery mechanism. In some implementations, a user that is reading a physical book can enter location information using a computer, phone, or other device, and the location information can be stored on a server for use in bookmarking a subsequent starting location using a different delivery mechanism.

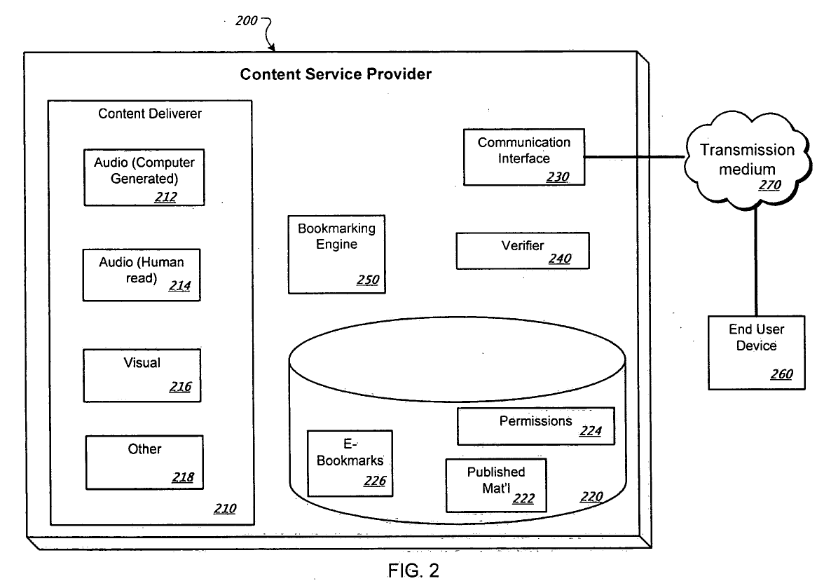

FIG. 2 is a block diagram of a content service provider 200 for flexible delivery of published material using electronic bookmarking. In general, content service provider 200 includes a content delivery module 210 that retrieves from data store 220 published material 222 and forwards it through communication interface 230 in response to a request for content from end user device 260.

Content service provider 200 can include multiple computers and data storage devices that communicate with one another in a manner that is transparent to end user device 260. The content service provider can include a content delivery module 210 (e.g., a content delivery server or module). The content delivery module 210 can access the published material 222 and prepare the published material 222 for delivery to end user device 260. For example, published material 222 can be stored in a text searchable portable document format (PDF). A request for computer-generated audio can prompt the content delivery module 210 to access the stored PDF, examine and translate the text into computer generated speech using computer generated audio module 212, buffer the speech before playback, format the buffered speech for delivery, and then finally deliver the computer generated speech through communications interface 230. Similarly, other modules, such as human recorded audio module 214, visual module 216, or other modules 218, can be utilized to facilitate the preparation of published material 222 for delivery using a delivery mechanism associated with the respective module.

Data store 220 stores published material 222 or pointers thereto, permissions 224, and electronic bookmarks 226. Data store 220 can be distributed data storage devices that communicate with each other and service requests for data from other modules within the content service provider 200. Published material 222 can be stored within data store 220 or pointers, such as file transfer protocol (FTP) links, can be stored in lieu of the full version of the published material 222. This can allow a third party to host the published material. When the content delivery module 210 requests a particular published material 222, the link to the third party host can be returned in response to the request. The data store also contains electronic bookmarks 226 and permissions 224. The permissions 224 can be used by verifier 240 to validate a request from an end user device 260. The request will typically identify the user of the end user device (e.g., using authentication information stored on the device or entered by the user), which can be used to search the permissions 224 to determine whether the user has permission to access the published material.

An electronic bookmark 226 defines where the content delivery module 210 starts delivering published materials to the user during the next reading or listening session. Electronic bookmarks 226 can be stored in any of a variety of formats. For example, an electronic bookmark 226 can be a value indicating a relative position in the published material. The sentences in a published material could be counted and the electronic bookmark 226 can indicate the percentage of sentences that precede the point at which the user stopped. The same can be done with paragraphs, book lines, and chapters. The electronic bookmark 226 can be an identifier that expressly indicates the page and line number at which the user stopped. The electronic bookmarks 226 can be used to identify the page, line number, paragraph, sentence, or other subdivision of the book at which presentation of the published material should commence when the user subsequently accesses the published material 222. The bookmarking engine 250 can generate, modify, and delete bookmarks associated with a user's access to the published material 222. For example, a request to bookmark a particular page in a novel can be routed to the bookmarking engine 250. In response to the request, the bookmarking engine 250 can determine a relative position of the page and store the relative position in electronic bookmarks 226.

Communication interface 230 can receive requests and communicate responses to end user devices 260 using transmission media 270. The communication interface 230 can be implemented as software, hardware, or a combination of the two, and can be a single entity or distributed across a number of modules. For example, one communication interface 230 can be associated with a particular transmission medium 270 and other interfaces 230 can be associated with other transmission media 270. The communication interface 230 receives requests and can route them to the appropriate module, such as verifier module 240 and content delivery module 210. The communication interface 230 can be used to format responses, such as responses delivering published material, for transport over a transmission medium. For example, computer generated audio can be delivered over the internet using a streamed audio file, voice over internet protocol (VoIP), or other mechanism. In such cases, the audio generated from the content deliverer would be the same, but the format of delivery would be different. The communication interface 230 can be used to format the computer generated audio to the appropriate format.

In operation, for example, a user can request delivery to a vehicle communications system of human recorded audio of a magazine called Home Networking. The request can be received by communication interface 230, which routes the request to the verifier 240 to determine whether the user has permission to access Home Networking magazine. The verifier module 240 can access permissions 224 using the identity of the requesting user and the name or other identifier of the magazine to verify the user's eligibility. If the user is eligible, the verifier module 240 can forward the request to the content delivery module 210.

The content delivery module 210 can access the published material 222 to determine whether the request for human recorded audio can be fulfilled. In this example, the Home Networking magazine does not have human recorded audio available. The content delivery module 210 can default to computer generated audio to be delivered in lieu of the human recorded audio. The computer generated audio module 212 can then access the electronic bookmarks 226 to determine whether the user has a bookmark associated with the Home Networking magazine, which in this example the user has a bookmark that indicates reading should commence on the second page of the magazine. The computer generated audio module 212 can then access published material 222 to retrieve the text of Home Networking magazine beginning on the second page and begin the translation of the text to speech. The speech can then be communicated to the communication interface for output to the vehicle communication system 260 through the transmission media 270.

In another example, the user may issue a command to set a bookmark at the current point of playback, which may be the tenth page of Home Networking magazine. A request can be received by the communication interface 230 and routed to the bookmarking engine 250. The bookmarking engine 250 can delete the previous bookmark associated with the second page of the Home Networking magazine and create and store a new electronic bookmark 226 associated with the user and the tenth page of Home Networking magazine. The functionality described with respect to the modules may be performed by other modules.

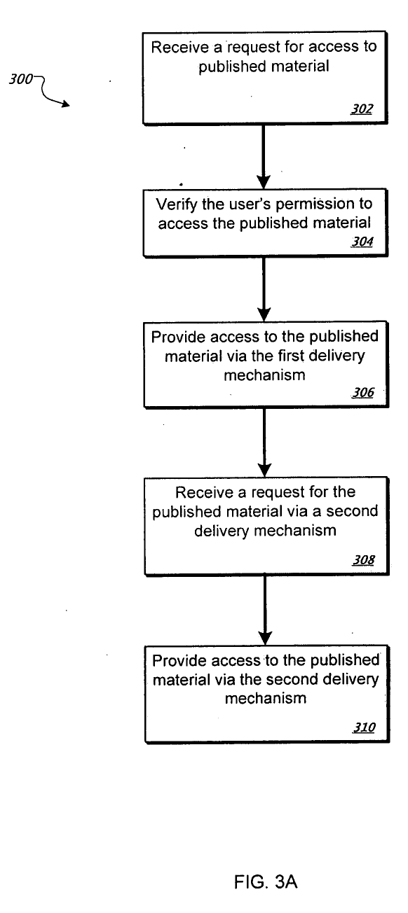

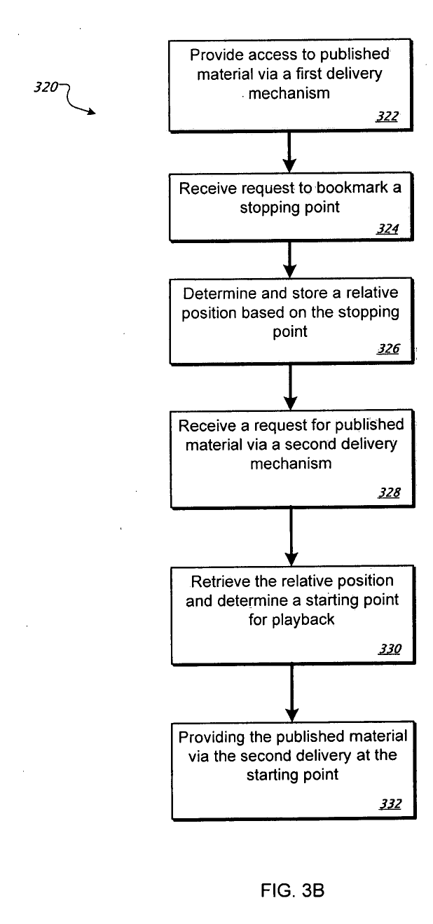

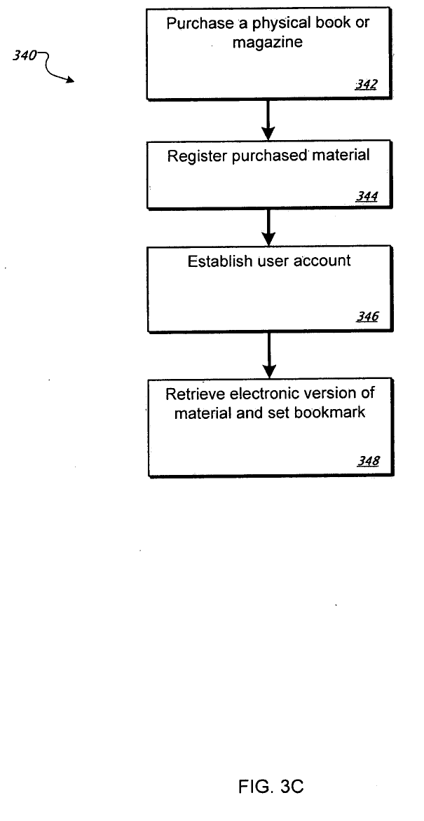

FIG. 3A is a flowchart of a process 300 for flexible integrated delivery of published material. At 302, a request for access to published material is received. The request can include, among other things, a variety of parameters, such as an identifier of the user originating the request, the method of delivery, and the name or identifier of the published material. There can be a number of delivery mechanisms from which the user can choose for delivery of the published material. Delivery mechanisms can be used to deliver audio, visual, and even tactile renderings of the published material, to name a few. Delivery mechanisms can also involve different transmission media, different end user devices, and different modes of operating end user devices. For example, a delivery mechanism can include delivering content across an internet connection, a mobile phone network, and/or a vehicle-enabled access network. A vehicle-enabled access network can involve use of a vehicle's communications system, such as OnStar or TeleAid, for example. At 304, verification of the user's permissions to access the published material is performed. At 306, the user is provided access to the published material via a first delivery mechanism or channel. For example, the published material can be made available in audio via a cellular telephone network.

At 308, a request for the published material via a second delivery mechanism is received. The request, like the first request, can include a number of parameters. The user can be re-verified. At 310, access to the published material via the second delivery mechanism is provided. For example, the published material can be made available in text for delivery to a smartphone over the internet.

FIG. 3B is a flowchart of a process 320 for electronic bookmarking. At 322, the published material can be provided via a first delivery mechanism. At 324, a request to bookmark a stopping point in the published material can be received. The request to bookmark can include the identity of the user, the name or identifier of the publication, and the position of the stopping point. The position of the stopping point can be identified by chapter, page, paragraph, line, sentence, and/or a combination of any of these. At 326, a relative position can be determined based on stopping point and stored. The relative position functions as an electronic bookmark across different delivery mechanisms. The relative position can be associated with an electronic file that corresponds to the published material.

At 328, a request for access to the published material via a second delivery mechanism is received. At 330, a search for the relative position can be performed and the relative position retrieved. The relative position can be used to determine a starting point for playback via the second delivery mechanism. In certain instances, the starting point and the stopping point are the same. At 332, the published material is provided for access by the user beginning at the starting point.

FIG. 3C is a flowchart of a process 340 for subscribing to a flexible integrated delivery of published material. At 342, a customer or potential subscriber can purchase a physical book or magazine. The purchase can be made at any of a variety of book sellers. For example, a customer can purchase a book from an online retailer or a local bookstore. Alternatively, the potential subscriber can purchase the material in electronic form, either on physical media or for delivery via a network. At 344, the customer can register the purchased material. The customer can register online with the content service provider by identifying the book or other purchased content. Verification of the purchase can be performed by requiring the customer to provide some proof of purchase or requiring the customer sign some type of acknowledgement. In some instances, the retailer that sold the book or other content can provide confirmation of the purchase by the customer and/or register the customer directly.

At 346, a user account can be established for the customer if the published material is available from the content service provider. At 348, the electronic version of the published material can be retrieved and an electronic bookmark associated with the customer for the published material can be created to point to the first page of the published material by default.

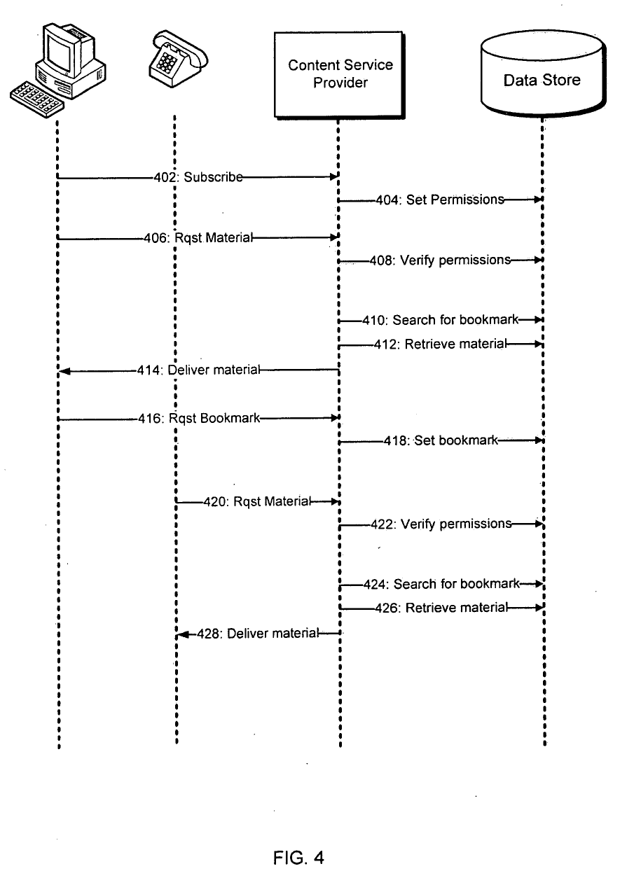

FIG. 4 is a flow diagram of a process for flexible integrated delivery of published material. At 402, the first communications device sends a message to the content service provider to subscribe a user to a service that allows receiving published material via a two or more delivery mechanisms. The message sent by the first communications device can contain the user's preferred content delivery mechanism when using the first communications device or other devices. At 404, the content service provider sets permissions for the user in the data store. At 406, the first communications device sends a request for published material. At 408, the content service provider verifies permissions associated with the user to determine whether the user has access to the requested published material. At 410 and 412, after verifying the user has the appropriate credentials, the content service provider can search for a bookmark and retrieve the material from the data store in accordance with the bookmark. The content service provider can deliver the material to the first communications device at 414. At 416, the first communications device can send a request to bookmark the published material. At 418, the content service provider can set the bookmark in the data store.

At 420, the second communications device can send a request for the published material. At 422, the content service provider verifies permissions associated with the user to determine whether the user has access to the requested published material. At 424 and 426, after verifying the user has the appropriate credentials, the content service provider can search for a bookmark and retrieve the material from the data store. The content service provider can deliver the material to the second communications device at 428.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer-readable medium for execution by, or to control the operation of, data processing apparatus. The computer-readable medium can be a machine-readable storage device, a machine-readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of embodiments have been described. Nevertheless, it will be understood that various modifications may be made without departing from the spirit and scope of the invention. For example, a request for a particular publication material can be initiated by prompting the user to select from a list of available titles. Accordingly, other embodiments are within the scope of the following claims.

What is claimed is:

1. A method comprising:
providing a user with access to media content via a first delivery mechanism of a plurality of delivery mechanisms, the plurality of delivery mechanisms comprising at least one delivery mechanism operable to deliver an audio rendering of the media content and at least one delivery mechanism operable to deliver a visual rendering of the media content;
receiving a request from the user to bookmark a stopping point in the media content;
determining a relative position in the media content based on the stopping point;
storing the relative position;
receiving a request from the user for access to the media content via a second delivery mechanism of the plurality of delivery mechanisms;
retrieving the relative position;
determining a starting point for playback of the media content via the second delivery mechanism based on the relative position; and
providing the user with access to the media content via the second delivery mechanism, the access via the second delivery mechanism beginning at the starting point.

2. The method of claim 1, wherein the request from the user to bookmark is initiated by the user issuing a voice command; and the method further comprising automatically determining the relative position and storing the relative position in response to the voice command.

3. The method of claim 1, the method further comprising:
receiving a request for access by the user to the media content via the first delivery;
verifying that the user has permission to access the media content;
determining whether a relative position in the media content has been previously stored;
if a relative position has been previously stored:
retrieving the relative position;
determining a particular starting point for playback of the media content via the first delivery mechanism based on the relative position; and
providing the user with access to the media content via the first delivery mechanism, the access via the first delivery mechanism beginning at the particular starting point; and
if a relative position has not been previously stored, providing the user with access to the media content via the first delivery mechanism, the access via the first delivery mechanism beginning at a default starting point of the media content.

4. The method of claim 1, wherein the at least one delivery mechanism operable to deliver the audio rendering comprises at least one of: an internet connection, a mobile phone network, and a vehicle-enabled access network.

5. The method of claim 1, wherein providing the user with access to the media content via the first delivery mechanism is operable to deliver a visual rendering of the media content, and wherein the second delivery mechanism is operable to deliver an audio rendering of the media content.

6. The method of claim 1, wherein the request from the user to bookmark a stopping point is submitted manually by the user and identifies a location in a hard copy of the media content.

7. The method of claim 1, wherein the particular point comprises a page and paragraph number in the media content.

8. The method of claim 1, wherein the stopping point is in the middle of a particular paragraph and the starting point is at the beginning of the particular paragraph.

9. A system comprising:
a memory for storing relative positions in media contents;
one or more data processing apparatuses operable to interact with the memory and to perform operations comprising:
providing a user with access to media content via a first delivery mechanism of a plurality of delivery mechanisms, the plurality of delivery mechanisms comprising at least one delivery mechanism operable to deliver an audio rendering of the media content and at least one delivery mechanism operable to deliver a visual rendering of the media content;
receiving a request from the user to bookmark a stopping point in the media content;
determining a relative position in the media content based on the stopping point;
storing the relative position in the memory;
receiving a request from the user for access to the media content via a second delivery mechanism of the plurality of delivery mechanisms;
retrieving the relative position from the memory;
determining a starting point for playback of the media content via the second delivery mechanism based on the relative position; and
providing the user with access to the media content via the second delivery mechanism, the access via the second delivery mechanism beginning at the starting point.

10. The system of claim 9, wherein the request from the user to bookmark is initiated by the user issuing a voice command; and the method further comprising automatically determining the relative position and storing the relative position in response to the voice command.

11. The system of claim 9, the operations further comprising:
receiving a request for access by the user to the media content via the first delivery;
verifying that the user has permission to access the media content;
determining whether a relative position in the media content has been previously stored;
if a relative position has been previously stored:
retrieving the relative position;
determining a particular starting point for playback of the media content via the first delivery mechanism based on the relative position; and
providing the user with access to the media content via the first delivery mechanism, the access via the first delivery mechanism beginning at the particular starting point; and
if a relative position has not been previously stored, providing the user with access to the media content via the first delivery mechanism, the access via the first delivery mechanism beginning at a default starting point of the media content.

12. The system of claim 9, wherein the at least one delivery mechanism operable to deliver the audio rendering comprises at least one of: an internet connection, a mobile phone network, and a vehicle-enabled access network.

13. The system of claim 9, wherein providing the user with access to the media content via the first delivery mechanism is operable to deliver a visual rendering of the media content, and wherein the second delivery mechanism is operable to deliver an audio rendering of the media content.

14. The system of claim 9, wherein the request from the user to bookmark a stopping point is submitted manually by the user and identifies a location in a hard copy of the media content.

15. The system of claim 9, wherein the particular point comprises a page and paragraph number in the media content.

16. The system of claim 9, wherein the stopping point is in the middle of a particular paragraph and the starting point is at the beginning of the particular paragraph.

17. A computer program product, encoded on a computer-readable medium, operable to cause data processing apparatus to perform operations comprising:
providing a user with access to media content via a first delivery mechanism of a plurality of delivery mechanisms, the plurality of delivery mechanisms comprising at least one delivery mechanism operable to deliver an audio rendering of the media content and at least one delivery mechanism operable to deliver a visual rendering of the media content;
receiving a request from the user to bookmark a stopping point in the media content;
determining a relative position in the media content based on the stopping point;
storing the relative position;
receiving a request from the user for access to the media content via a second delivery mechanism of the plurality of delivery mechanisms;
retrieving the relative position;
determining a starting point for playback of the media content via the second delivery mechanism based on the relative position; and
providing the user with access to the media content via the second delivery mechanism, the access via the second delivery mechanism beginning at the starting point.

18. The product of claim 17, wherein the request from the user to bookmark is initiated by the user issuing a voice command; and the method further comprising automatically determining the relative position and storing the relative position in response to the voice command.

19. The product of claim 17, the operations further comprising:
receiving a request for access by the user to the media content via the first delivery;
verifying that the user has permission to access the media content;
determining whether a relative position in the media content has been previously stored;
if a relative position has been previously stored:
retrieving the relative position;
determining a particular starting point for playback of the media content via the first delivery mechanism based on the relative position; and
providing the user with access to the media content via the first delivery mechanism, the access via the first delivery mechanism beginning at the particular starting point; and
if a relative position has not been previously stored, providing the user with access to the media content via the first delivery mechanism, the access via the first delivery mechanism beginning at a default starting point of the media content.

20. The product of claim 17, wherein the at least one delivery mechanism operable to deliver the audio rendering comprises at least one of: an internet connection, a mobile phone network, and a vehicle-enabled access network.

21. The product of claim 17, wherein providing the user with access to the media content via the first delivery mechanism is operable to deliver a visual rendering of the media content, and wherein the second delivery mechanism is operable to deliver an audio rendering of the media content.

22. The product of claim 17, wherein the request from the user to bookmark a stopping point is submitted manually by the user and identifies a location in a hard copy of the media content.

23. The product of claim 17, wherein the particular point comprises a page and paragraph number in the media content.

24. The product of claim 17, wherein the stopping point is in the middle of a particular paragraph and the starting point is at the beginning of the particular paragraph.
